(19) United States
(12) Patent Application Publication
(10) Pub. No.: US 2023/0022610 A1
(43) Pub. Date: Jan. 26, 2023

(54) ELECTRICITY PRODUCTION FACILITY COMPRISING A FUEL CELL AND A CHEMICAL REACTOR SUITABLE FOR PRODUCING FUEL FOR SAID FUEL CELL USING HEAT RELEASED BY A BATTERY ASSOCIATED PROCESS

(71) Applicant: Bruno Sanglé-Ferrière, PARIS (FR)

(72) Inventor: Bruno Sanglé-Ferrière, PARIS (FR)

(21) Appl. No.: 17/869,459

(22) Filed: Jul. 20, 2022

(30) Foreign Application Priority Data
Jul. 21, 2021 (FR) FR2107884

(51) Int. Cl. H01M 8/0612; H01M 8/1233; B01J 19/24

(52) U.S. Cl. CPC H01M 8/0631; H01M 8/1233; B01J 19/245

(57) ABSTRACT

The present invention is a method for producing electricity comprising a fuel cell which makes it possible to valorize the heat given off by the cell to generate fuel for said fuel cell by a process of thermal dissociation, applied to the product of the same chemical composition than that produced by the cell, at least part of the heat given off by the cell being supplied to at least one of the endothermic reactions of said dissociation process.

### TECHNICAL AREA

The present invention relates to an electricity production installation comprising a non-galvanic fuel cell.

### PRIOR ART

Hydrogen fuel cells are known to operate at high temperatures, ranging in particular from 450° C. to 1000° C. In these cells, the hydrogen is oxidized, either at the cathode, if the hydrogen crosses the electrolyte in ionic form towards it, or at the anode if the oxygen crosses the electrolyte towards the anode as in the case of SOFC solid oxide batteries. The energy efficiency of all these fuel cells, however, rarely exceeds 60% of the energy.

It is known to use the heat released by these batteries during their operation to operate turbines which also provide electricity. We then speak of co-production. However, the recovery of the heat released in the production of electricity is not sufficient.

The document JP 2005 306624 A describes the use of the heat produced by the combustion in a burner of the residual gases from the fuel cell, to provide thermal energy to the reactors where the stages of separation and concentration of products intended for the production of hydrogen, but does not recycle all the heat given off by the electrolyte nor the electrodes of the cell in which the dihydrogen reacts with the dioxygen, possibly using only the part of the said heat transferred to the dioxygen and dihydrogen which do not have not reacted, and further requiring a combustion chamber in which the dioxygen burns the dihydrogen outside the electrochemical cell; while instead, the dihydrogen could be separated from the water with which it is mixed at the outlet of the anode by simple cooling under a pressure lower than the critical pressure of water, to be reintroduced at the inlet of said cell, or else be separated by a membrane.

The document JP H09 320627 A describes an installation which makes it possible to use, when starting up the installation, the heat produced by a fuel cell using phosphoric acid as electrolyte. The fuel cell is completely powered by the chemical reactions taking place in the hydrogen and oxygen production unit, which operates with the heat generated by the cell. This installation does not allow recycling of the products of the electrochemical reaction of the cell, for the production of dihydrogen and dioxygen. In addition, the installation creates toxic co-products, the phosphorus reacting with the hydrogen.

Documents US 2020/306624 A and EP 1 851 816 A2 describe hydrocarbon reforming processes which allow the production of hydrogen.

Ullmnn's Encyclopedia of Industrial Chemistry (ISBN 978-3-52-730673-2) describes, in its chapter “Hyfdrogen2, Production”, various chemical processes for the production of hydrogen, including processes for the decomposition of water into dihydrogen and dioxygen.

### TECHNICAL PROBLEM

None of these methods, however, makes it possible to improve the efficiency of the production of electrical energy from a fuel cell by describing a method where an installation whose inputs are the same as those of said fuel cell, by recovering the heat produced by said battery. However, apart from the problem of partial combustion of the fuel of the cell, in particular dihydrogen, the performance of a hydrogen cell is significantly affected by its thermal release which takes place at its electrodes but also in its electrolyte through which ions pass.

### BRIEF DESCRIPTION OF THE INVENTION

The present invention relates to a method for producing electricity implementing a non-galvanic fuel cell, said method making it possible to valorize the heat given off by said cell to generate fuel for said fuel cell by a thermal dissociation process, applied to the product of the same chemical composition as that produced by said cell, at least part of the heat given off by said cell being supplied to at least one of the endothermic reactions of said dissociation process, and the oxidizers and fuels of the fuel cell not reacting directly with each other outside of said fuel cell.

The fuel enters the installation and mixes with the fuel possibly resulting from the reactors of the chemical cycle to be introduced into a fuel cell, said fuel cell producing electricity which is one of the products of the installation, as well a product which is partly extracted from the installation and partly recycled to the chemical cycle reactors, the heat released by the cell being transferred to the chemical cycle which produces fuel.

The fuel cell is for example a solid oxide hydrogen cell whose combustion product is water, formed at the electrode in contact with the hydrogen. A dihydrogen concentrator (150) is advantageously arranged to extract the water from the water-dihydrogen mixture, for example consisting of a metal membrane, of vanadium covered with silicon oxide on each face, themselves covered with a fine 20-micron layer of platinum as described in the article: ‘Hydrogen-permeable metal membranes for high-temperature gas separations’ published by David Edlund, Dwayne Friesen, Bruce Johnson and William Pledge in 1994 in the journal ‘Gas Separation and Purification’ Volume 8.

### Water splitting processes

The process of thermal dissociation of water is for example the iodine sulfur cycle or any other similar cycle from hydrogen halide using for example bromine or chlorine instead of iodine, during which the reactions used are respectively 2 H₂SO₄→2 SO₂+2 H₂O+O₂; 2HBr→Br₂+H₂; 2HBr→Br₂+H₂ and: 2 H₂SO₄→2 SO₂+2 H₂O+O₂; 2HCl→Cl₂+H₂; 2HCl→Cl₂+H₂. Each of the products of the thermal dissociation of water can then be used in part by the hydrogen fuel cell. As a variant, the products dissociated by the thermal dissociation process all come from the overall chemical reaction taking place in the cell, and all the products resulting from the thermal dissociation are consumed by said cell.

The sulfur iodine cycle allows in a first reaction at for example 120° C. between di-iodine, sulfur dioxide and water to produce hydrogen iodide and sulfuric acid (I₂+SO₂+2 H₂O→2 HI+H₂SO₄), the hydrogen iodide being recycled in a first endothermic reaction at for example 650° C. in di-iodine and dihydrogen (2 HI→I₂+H₂) and the sulfuric acid in sulphur dioxide, water and dioxygen (2 H₂SO₄→2 SO₂+2 H₂O+O₂) in a second endothermic reaction, for example at 830° C.; the heat required for the first and/or second endothermic reaction coming from the hydrogen fuel cell, either through a thermal connection between said fuel cell and the reactor(s) of the first and/or second endothermic reaction, or/and transported to the said reactors by the water released from the hydrogen fuel cell during its operation.

Alternatively, the thermal water dissociation process can use an alkali metal hydride in which water mixed with the alkali metal reacts to form a hydride of the alkali metal and oxygen (H₂O+2 Me−>2MeH+½O₂) while the alkali metal hydride is transformed in another reactor into metal and dihydrogen (2MeH−>2Me+H₂).

Alternatively still, the dissociation of water can be done using Iron III chloride and Iron II chloride (6FeCl₂+8 H₂O−>2Fe₃O₄+12HCl+2H₂; 2Fe₃O₄+12HCl+3Cl₂−>6FeCl₃+6H₂O+O₂ and 6FeCl₃−>6FeCl₂+3Cl₂).

Alternatively still the dissociation of water can be done using vanadium chloride and vanadium tetrachloride (Cl₂+H₂−>2HCl+½O₂; 2HCl+VCl₂−>2VCl₃+H₂; 2VCl₃−>VCl₂+VCl₄2VCl₄−>2VCl₃+Cl₂)

In yet another version, the process for the thermal dissociation of water can use hydrocarbons, methane reacting for example in a first reactor with water to form dihydrogen and carbon monoxide (CH₄+H₂O−>CO+3H₂), carbon monoxide and dihydrogen reacting in a second reactor to form methanol (CO+2H₂−>CH₃OH), methanol reacting in a third reactor with arsenate to form arsenious anhydride and dioxygen (CH₃OH+As₂O₄−>½As₂O₃+½O₂), a fourth and a fifth reactor allowing the formation of arsenate and dioxygen from arsenious anhydride (1/2 As₂O₅−>½As₂O₃+½O₂ and ½As₂O₅+½As₂O₃−>As₂O₄).

The present invention also relates to an installation for the production of electricity making it possible to implement the method for producing electricity described above. The installation including for example:

at least one fuel cell generating electricity and using a fuel, such as dihydrogen, as reducing fuel and operating at a given operating temperature, said cell being connected to a main source of dihydrogen;

a chemical reactor/chemical production unit thermally connected to said cell and allowing the chemical production of fuel from the product of the reaction taking place in the cell, or from a chemical compound of the same composition, via at least an endothermic chemical reaction which takes place at a temperature less than or equal to said operating temperature of said battery, and

means for introducing into said cell the dihydrogen produced in said chemical reactor.

In a preferred embodiment of the invention, said chemical reactor/said chemical production unit comprises at least one main compartment/main reactor allowing the chemical production of dihydrogen and di-iodine from hydrogen iodide (HI), a first secondary compartment/first secondary reactor allowing the chemical production of dioxygen from sulfuric acid (H₂SO₄), and/or at least a second secondary compartment which allows the reaction between di-iodine, sulfur dioxide and water, which produces hydrogen iodide and sulfuric acid. This second secondary compartment therefore contains diatomic iodine, water and sulfur dioxide and possibly the products of this reaction, i.e. hydrogen iodide and sulfuric acid. Said first compartment/secondary reactor and/or said reactor/main compartment are thermally connected to said cell. The production unit further comprises means for introducing di-iodine produced in said main compartment/reactor to the second compartment/secondary reactor, means for introducing sulfuric acid produced in said second compartment/secondary reactor in said first compartment/secondary reactor and means for introducing the dioxygen produced in said first compartment/secondary reactor to said cell, so that the latter serves there as oxidizer.

The cycles of the hydrogen/dioxygen production reactions are not limited according to the invention. This may be, for example, one of the water-splitting processes described above.

The fuel cell of the installation of the invention is connected to a main source of fuel and to a main source of oxidizer. The supply of fuel and oxidizer provided by the operation of the chemical unit or the chemical reactor is an additional fuel and/or oxidizer contribution.

Advantageously, the chemical reactor/said chemical production unit comprises at least one main compartment/main reactor allowing the production of dihydrogen from hydrogen iodide, a first secondary compartment/first secondary reactor allowing the reaction between two molecules of sulfuric acid to produce in particular dioxygen and at least one second secondary compartment/second secondary reactor which allows the reaction between di-iodine, sulfur oxide and water to produce sulfuric acid and iodide d 'hydrogen. The cycle used is then that described in FIG. 1.

The installation according to the invention therefore makes it possible to produce, at the same time, electricity, dihydrogen and dioxygen, which are used as fuel in the cell within said installation. The heat generated continuously by the hydrogen fuel cell during its operation is used for the production of dihydrogen and/or dioxygen during endothermic reactions and the remaining heat, if any, can still be used for the production electricity by a turbine or for heating, for example.

According to a variant that can be combined with each of the aforementioned embodiments, the cell is thermally connected only to said first reactor/secondary compartment, the main reactor being thermally connected to the first secondary reactor and the second secondary reactor to the main reactor.

According to another variant, the cell is thermally connected to the three reactors.

The chemical production unit includes reactors thermally connected to each other, either directly by contact or by a heat transfer fluid circuit. The use of a heat exchanger operating with a heat transfer fluid makes it possible to regulate the flow of heat transmitted by regulating the flow of heat transfer fluid. A heat transfer fluid can circulate in the walls of the main reactor to lower the temperature and transfer the calories which have passed through said walls, which are themselves preferably wrapped up for thermal insulation, to the second secondary reactor.

The chemical reactor or the chemical production unit can be configured to receive the heat released by the cell directly by convection or conduction. The installation may also comprise means of thermal connection between said cell and said main reactor/compartment and/or between said cell and said first reactor/secondary compartment which make it possible in particular to continuously supply the heat given off by said fuel cell and regulate the amount of heat supplied. These thermal connection means can be or include, for example, a heat transfer fluid circuit circulating between the cell next to the anode and cathode, and the reactor.

The endothermic chemical reaction 2HI→I₂+H₂ can take place in the gas phase at 830° C. The main compartment therefore contains hydrogen iodide and possibly the reaction products (i.e. dihydrogen and di-iodine).

The first secondary compartment/reactor allowing the reaction between two molecules of sulfuric acid to produce dioxygen (this compartment/reactor therefore contains at least sulfuric acid and possibly the reaction products i.e. sulfur dioxide, water and dioxygen) The second compartment/secondary reactor allows the reaction between di-iodine, sulfur oxide and water, which produces hydrogen iodide and this second compartment/secondary reactor therefore contains diatomic iodine, water and sulfur dioxide and possibly the products of this reaction, i.e. hydrogen iodide and sulfuric acid. said secondary compartments/reactors may be thermally connected to said main compartment and/or to said cell.

Indeed, the publication entitled “Sulfur-Iodine Thermochemical Cycle”, by P. Pickard, and published on May 17, 2006 in the journal Sandia National Labs, describes a series of reactions allowing the production of dihydrogen that respects the environment. The aforementioned Sulfur-Iodine cycle makes it possible, using high heat, to produce hydrogen. The reaction I₂+SO₂+2 H₂O→2 HI+H2S0₄ operates at 120° C. The two endothermic reactions: 2 H₂SO₄→2 SO₂+2 H₂O+O₂ and 2 HI→I₂+H₂ are preferably carried out, respectively at 830° C. and 650° C., the SOFC cell preferably operating at 860° C. or more.

Throughout the present application, the expression “reactor allowing the reaction between A and B” encompasses a reactor containing the reactants A and B and optionally the products and by-products of this reaction.

Advantageously, said operating temperature of said cell is greater than or equal to 850° C. or 860° C. It is advantageously less than or equal to 1000° C. or 1100° C.

The cell is not limited according to the invention. It can be a proton exchange membrane hydrogen fuel cell or a solid oxide hydrogen fuel cell (SOFC). It can also be, for example, a direct methanol cell, for example with a solid oxide electrolyte whose fuel is methanol; the reactions then being at the anode: CH₃OH+3 O²⁻→CO₂+2 H₂O+6e⁻and at the cathode: O₂+4 e−→2 O²⁻; then the carbon dioxide separated from the water, for example cooling and pressurizing for example at 30° C. under 1 atmosphere so that the water becomes liquid while the carbon dioxide remains gaseous; the water being regenerated into dihydrogen by one of the processes described above for dissociation of water, then the dihydrogen reacting in a separate reactor with carbon dioxide to form methanol according to the reaction: CO₂+3 H₂−>CH₃OH+H₂O

The cell is advantageously chosen from solid oxide fuel cells, which have a high operating temperature, that is to say, greater than 850° C.

According to the invention, the solid electrolyte of the SOFC battery (“solid oxide fuel cells”) is not limited. As this is a solid electrolyte of metal oxide(s) type, it can, for example, be chosen from yttrium oxides stabilized with zirconium (YSZ), scandium oxides stabilized with zirconium , (ScSZ), gadolinium doped with/with cerium oxides (GDC), bismuth stabilized with erbium oxide(s) (ERB), cerium oxides doped with one or more samarium oxides and mixtures of at least two of these oxides.

As this is a solid electrolyte containing or consisting of ceramics, it can, for example, be chosen from ceramics and in particular composite ceramics containing salts of cerium oxide(s), (CSCs).

The means of introduction into the chemical reactors can be simple pipes possibly equipped with nozzles preceded by compressors. The phase of di-iodine and sulfuric acid during their reintroduction is not limiting according to the invention. They can be liquid or gaseous, independently of each other, depending on the temperature and pressure conditions in the separators that equip the outlets of the reactor compartments.

The installation of the invention thus makes it possible to produce both dihydrogen and dioxygen which are used in the electrochemical reaction of the cell. The installation of the invention can therefore operate with a reduced supply of dihydrogen and/or external oxygen. It is therefore particularly ecological and proves to be economically advantageous.

The installation of the invention can be used to produce electric current, for example for industrial or domestic use, added to one or more electric motors for moving vehicles.

The present invention also relates to a method for producing electricity by means of a fuel cell using dihydrogen as a reducing fuel according to which the heat produced during the operation of said fuel cell is continuously used to chemically generate dihydrogen via the endothermic chemical reaction 2 HI→I₂+H₂, said hydrogen then possibly being introduced into said cell to serve there as fuel.

### DEFINITIONS

The terms “thermally connected” indicate that two or more elements are in a thermal relationship either directly, by contact allowing the phenomenon of conduction, or by means of a suitable liquid or gaseous heat transfer fluid.

The term “solid oxide” designates within the meaning of the invention a metal oxide allowing the transport of O²⁻ ions.

The terms “solid oxide fuel cell” designate any electrochemical device making it possible to produce electricity by oxidation of a fuel and comprising a solid electrolyte which may be a solid metal oxide, a mixture of metal oxides or a ceramic.

### FIGURES

The present invention, its characteristics and the various advantages it provides will appear better on reading the following description, presented by way of illustrative and non-limiting example, and which refers to the appended FIGS. 1 to 4:

FIG. 1 represents a schematic view of a particular embodiment of the present invention; and

FIG. 2 represents a diagram of the various flows of matter and energy necessary for the invention, entering, leaving and internal to the installation.

FIG. 3 represents a diagram of the various flows of material and energy necessary for the invention, entering, leaving and internal to the installation, the fuel being methanol.

FIG. 4 represents a diagram of the various flows of material and energy necessary for the invention, using a dihydrogen-water separator making it possible to maintain the proportion of dihydrogen in the gaseous mixture supplied to the anode of the cell.

### EXAMPLES

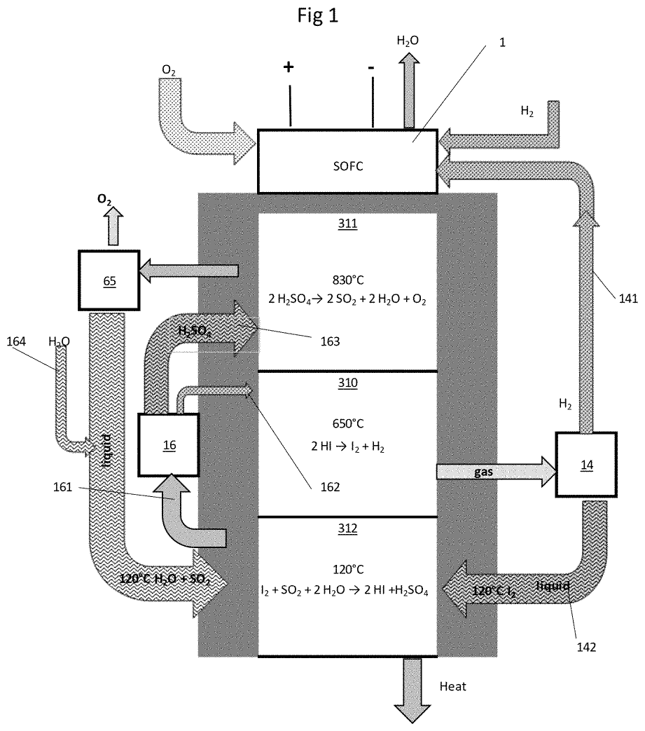

With reference to FIG. 1, a first embodiment of the invention will now be described. The installation comprises a cell 1, which is a solid metal oxide fuel cell. Despite its operation at high temperature (from 850° C. to 1000° C.), cell 1 gives off heat. Cell 1 is thermally connected to a chemical reactor 3, which has three compartments. A thermal gradient is present in the chemical reactor 3 in order to ensure the appropriate reaction temperatures. The two upper compartments of the reactor are thermally connected to each other. The chemical reactor 3 comprises a main compartment 310 which is central in FIG. 1. A first secondary compartment 311 is located above the main compartment 310. This first secondary compartment 311 is arranged so as to first recover the heat produced by the battery 1 so that the temperature within it is higher than in the main compartment 310. A second secondary compartment 312 is arranged under the main compartment 310; the di-iodine from the separator 14 is advantageously brought into the tank 312 at a temperature of 120° C. in liquid form; a mixture of water and sulfur dioxide is supplied from the separator 65 and from a supply of water introduced via line 164, preferably also at a temperature of 120° C., and preferably under a pressure allowing that the two components of this gaseous mixture are liquid, the partial pressure of the sulfur dioxide being for example 50 bars.

The temperature of the second secondary compartment 312 is lower than that of the main compartment 310. In FIG. 1, the two upper compartments are thermally connected so that the heat is transmitted from the first secondary compartment to the main compartment. The arrangement of the compartments is not limited to that shown in FIG. 1. In particular, the compartments may not have a common wall through which the heat is transmitted. For example, a heat transfer liquid whose speed is regulated circulates between the 3 compartments to heat the said compartments and maintain them at the temperature necessary for the chemical reactions they house, if these are the sites of endothermic reactions.

The residual heat resulting from the operation of the installation is evacuated at the level of the second secondary compartment 312, for example by means of a cooling circuit (not shown) in which a heat transfer liquid circulates. A portion of this circuit crosses said compartment or is in contact with the wall of the latter. This heat can be used, for example, to produce electricity by means of a turbine. For this purpose, the installation may also include an electricity production turbine.

Still with reference to FIG. 1, the installation comprises a gas separator 14 whose inlet is located at the outlet of the main compartment 310. The outlet of this separator 14 is connected by a pipe 141 to the battery and by a pipe 142 to the second secondary compartment 312 The separator 14 can operate for example by concomitant expansion and cooling of the gas coming from the compartment 310, the di-iodine becoming liquid, between 184° C. and its critical temperature being 545.8° C. The liquid di-iodine is then optionally recompressed to reach the operating pressure of reactor 312.

The installation also comprises a separator 16 arranged at the entrance to the main compartment 310. The entrance to the separator 16 is connected via a pipe 161 to the second secondary compartment 312. The exit from the separator 16 is connected on the one hand to the main compartment 310 via a pipe 162 and on the other hand to the first compartment 311 via another pipe 163. At a temperature of 120° C., hydrogen iodide HI is gaseous and the other components, including sulfuric acid, are liquid under 50 bars. The reaction product mixture from reactor 312 is therefore preferably withdrawn from said reactor 312 after the reaction is complete. The pressure of the hydrogen iodide is advantageously lowered to the operating pressure of the reactor 310, to for example 10 bars.

A third separator 65 has its inlet connected to the first secondary compartment 311 (pipe not referenced and indicated by an arrow in FIG. 1) and its outlet connected by a first pipe (not shown) to the battery 1 and by a second pipe (not shown), to the second secondary compartment 312. The separator 65 operates for example by one or a series of compressions followed by cooling of the gas resulting from the decomposition of the sulfuric acid.

The operation of the installation will now be described with reference to FIG. 1. In the main compartment 310, the following chemical reaction takes place:

2HI→I₂+H₂. This reaction takes place at a temperature of about 650° C. in the gas phase.

In the first secondary compartment 311, the following chemical reaction takes place:

2H₂SO₄→2SO₂+2H₂O+O₂. This reaction takes place at a temperature of about 830° C. in the gas phase.

In the second secondary compartment, the following chemical reaction takes place:

I₂+SO₂+2H₂O→2HI+H₂SO₄. This reaction is endothermic and takes place at a temperature of the order of 120° C., the liquid di-iodine, mixed with liquid water and sulfur dioxide reacting advantageously with each other or, alternatively for example, the di-iodine in liquid form being vaporized in an atmosphere composed of water vapor and sulfur dioxide.

Cell 1 produces electricity supplying a network not shown in FIG. 1, by consuming dihydrogen. The heat given off by cell 1 is used to heat the first secondary compartment 311 of chemical reactor 3. In the particular embodiment represented here, only this compartment is thermally connected to cell 1. In this first secondary compartment, the acid sulfur reacts on itself to produce water, oxygen and sulfur dioxide. The reaction products are separated in the separator 65; the sulfur dioxide and the water are brought into the second secondary compartment 312; the oxygen is brought to cell 1 to serve, in addition to the oxygen brought elsewhere, for example from the outside air, to the oxidation-reduction reaction which takes place in the latter.

Due to the heat supplied, either directly from cell 1, or after transit in the first secondary compartment 311, the reaction which takes place in the main compartment 310 produces gaseous di-iodine and gaseous dihydrogen. These produced gases are separated in the separator 14; the dihydrogen is routed (via line 141) to cell 1 to react there. The gaseous iodine leaving the separator 14 is routed via line 142 to the second secondary compartment 312.

In the second secondary compartment 312, iodine reacts with sulfur dioxide and water from the first secondary compartment to produce hydrogen iodide (HI) and sulfuric acid. These products are separated in the separator 16; the hydrogen iodide is separated and brought to the main compartment 310 in order to feed the reaction in the latter; the sulfuric acid is brought into the first secondary compartment by line 163 connected to separator 16.

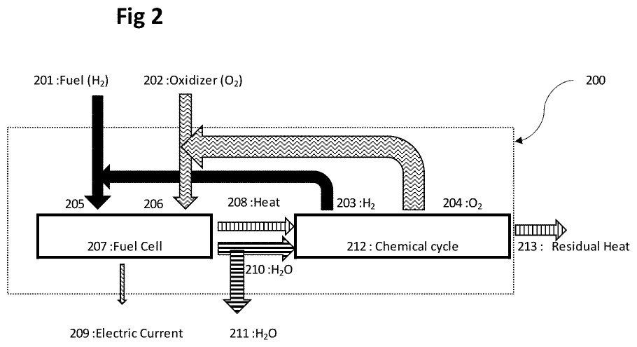

FIG. 2

The fuel 201 enters the installation 200 and mixes with the fuel 203 from the chemical cycle reactors 212 to be introduced at 205 into the fuel cell 207. Similarly, the oxidizer is introduced into the installation (202) to be mixed with the oxidizer 204 from the chemical cycle reactors 212, to be introduced at 206 into the fuel cell 207. The fuel cell produces electricity 209 which is one of the products of the installation, as well as a product, for example water which is partly extracted from the installation at 211 and partly recycled at 210 to the reactors of the chemical cycle. The heat 208 given off by the battery 207 is transferred to the chemical cycle 212. The chemical cycle produces fuel 203; oxidizer 204 and possibly residual heat 213 extracted from the installation.

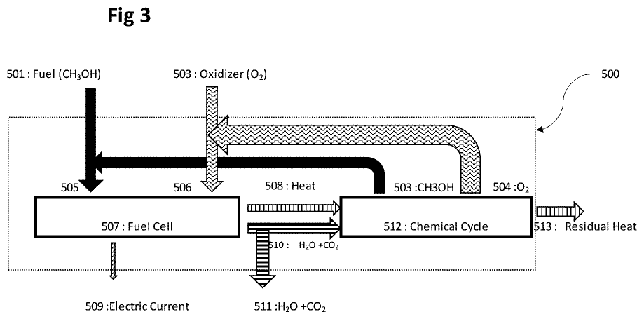

FIG. 3

The methanol 501 enters the installation 500 and mixes with the methanol 503 from the chemical cycle reactors 512 to be introduced at 505 into the direct methanol fuel cell 507. Similarly, the oxygen is introduced into the installation 502 to be mixed with the dioxygen 504 from the chemical cycle reactors 512, to be introduced at 506 into the fuel cell 507. The fuel cell produces electricity 509 which is one of the products of the installation, as well as water and carbon dioxide 511 which are partly extracted from the installation at 511 and partly recycled at 510 to the reactors of the chemical cycle. The heat 508 released by the battery 507 is transferred to the chemical cycle 512. The chemical cycle produces methanol 503; oxygen 504 and possibly residual heat 513 extracted from the installation.

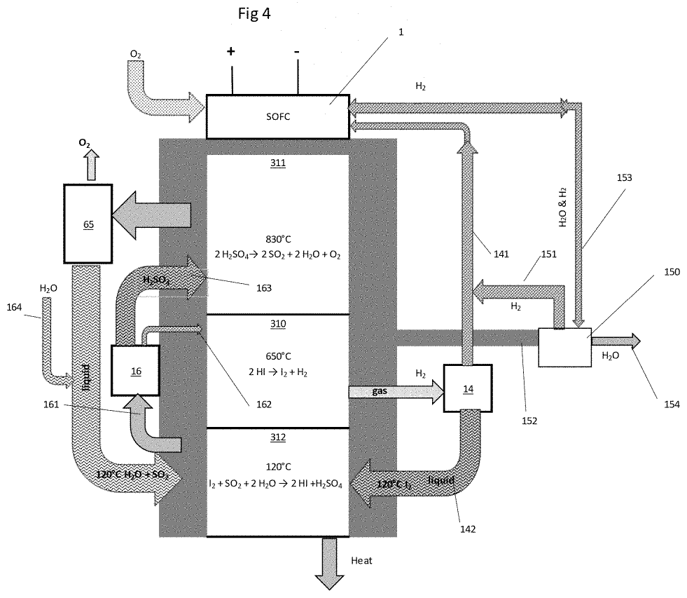

FIG. 4

The gaseous mixture brought to the anode of the battery 1 is put into circulation, that is to say brought and withdrawn by the conduit(s) 153 to be in thermal and gaseous communication with the device 150 which is in thermal contact by the connection 152 with the reactor 310 at a temperature of approximately 650° C. to which said gas mixture is therefore cooled. The gaseous mixture is enriched in dihydrogen in the device 150 using one or more metal membranes which makes it possible to extract the dihydrogen therefrom and/or the water which is rejected by the pipe 154. This water is advantageously used in part (not shown), to supply the dihydrogen production cycle, then being introduced into line 164. Similarly, the heat from this water is advantageously supplied to reactor 312 (not shown), or to heat the dihydrogen and/or dioxygen introduced into the installation.

What is claimed is:

1. A method for producing electricity implementing a non-galvanic fuel cell (1), said method comprising: recovering heat given off by the cell (1) to generate fuel for said fuel cell by a thermal dissociation process, and applying a product of the same chemical composition as one of the products of said fuel cell, wherein at least part of the heat given off by said fuel cell being supplied to at least one endothermic reactions of said dissociation process.

2. The method according to claim 1, wherein oxidizers and fuels of the fuel cell not reacting directly with each other outside of said cell.

3. The method according to claim 1, further comprising: the fuel enters an installation and mixes with the fuel, the said fuel cell (1) producing electricity which is one of the products of the installation, as well as at least one product which is partly extracted from the installation and partly recycled to the reactors of the chemical cycle, the heat released by the cell(1) being transferred to the chemical cycle which produces fuel.

4. The method according to claim 1, wherein each of the thermal dissociation products being used in part by the cell.

5. The method according to claim 1, wherein a part of the product or products of the cell being used for the chemical dissociation.

6. The method according claim 1 wherein the fuel cell (1) generating electricity uses dihydrogen as reducing fuel and operates at a selected operating temperature, said cell (1) being connected to a source of dihydrogen, and the process of thermal dissociation of water being the sulfur iodine cycle in which the following chemical reactions are carried out:
a. 2 H2SO4→2 SO2+2 H2O+O2
b. 2 HI→I2+H2
c. I2+SO2+2 H2O→2 HI+H2SO4

7. The method according to claim 1, wherein the fuel cell (1) generating electricity uses dihydrogen as reducing fuel and operates at a selected operating temperature, said cell (1) being connected to a source of dihydrogen, and the thermal water dissociation process being a cycle using bromine and during which the following reactions are used:
a. 2 H2SO4→2 SO2+2 H2O+O2
b. 2HBr→Br2+H2
c. Br2+SO2+2 H2O→2 HBr+H2SO4

8. The method according to claim 1, wherein the fuel cell (1) generating electricity uses dihydrogen as reducing fuel and operates at a selected operating temperature, said cell (1) being connected to a source of dihydrogen and the thermal water dissociation process is a sulfur cycle using chlorine and during which the following reactions are used:
a. 2 H2SO4→2 SO2 +2 H2O+O2
b. 2HCl→Cl2+H2
c. Cl2+SO2+2 H2O→2 HCl+H2SO4

9. The method according to claim 1, wherein the fuel cell (1) generating electricity uses dihydrogen as reducing fuel and operates at a selected operating temperature, said cell (1) being connected to a source of dihydrogen and the thermal water dissociation process uses an alkali metal hydride in which water mixed with the alkali metal reacts to form an alkali metal hydride and dioxygen (H2O+2 Me−>2MeH+½ O2) while the alkali metal hydride is transformed in another reactor into metal and dihydrogen (2MeH−>2Me+H2).

10. The method according to claim 1, wherein the fuel cell (1) generating electricity uses dihydrogen as reducing fuel and operates at a selected operating temperature, said cell (1) being connected to a source of dihydrogen and the thermal water dissociation process uses Iron III chloride and Iron II chloride (6FeCl2+8H2O−>2Fe3O4+12HCl+2H2; 2Fe3O4+12HCl+3Cl2−>6FeCl3+6H2O+O2 and 6FeCl 3−>6FeCl2+3Cl2).

11. The method according to claim 1, wherein the fuel cell (1) generating electricity uses dihydrogen as reducing fuel and operates at a selected operating temperature, said cell (1) being connected to a source of dihydrogen and the thermal water dissociation process uses vanadium chloride and vanadium tetrachloride (Cl2+H2−>2HCl+½ O2; 2HCl+VCl2−>2VCl3+H2; 2VCl3−>VCl2+VCl4; 2VCl4−>2VCl3+Cl2).

12. The method according to claim 1, wherein the fuel cell (1) generating electricity uses dihydrogen as reducing fuel and operates at a selected operating temperature, said cell (1) being connected to a source of dihydrogen and the thermal water dissociation process uses hydrocarbons.

13. The method according to claim 12, wherein the hydrocarbon being methane reacting in a first reactor with water to form dihydrogen and carbon monoxide (CH4+H2O−>CO+3H2), carbon monoxide and dihydrogen reacting in a second reactor to form methanol (CO+2H2−>CH3OH), methanol reacting in a third reactor with arsenate to form arsenious anhydride and dioxygen (CH3OH+As2O4−>½ As2O3+½ O2), a fourth and a fifth reactor providing the formation of arsenate and dioxygen from arsenious anhydride (1/2 As2O5−>½ As2O3+½ O2 and ½ As2O5+½ As2O3−>As2O4).

14. The method according to claim 1, wherein the fuel cell (1) generating electricity uses methanol as fuel.

15. A system for the production of electricity, comprising:
at least one fuel cell (1) generating electricity and using dihydrogen as reducing fuel and operating at a selected operating temperature, said cell (1) being connected to a main source of dihydrogen;
a chemical reactor/chemical production unit (3) thermally connected to said cell and providing the chemical production of dihydrogen via an endothermic chemical reaction which takes place at a temperature lower than or equal to said operating temperature of said cell (1), and
means (141) for introducing into said fuel cell (1) the dihydrogen produced in said chemical reactor (3), characterized in that said chemical reactor/said chemical production unit (3) comprises at least one main compartment/ main reactor (310) allowing the chemical production of dihydrogen, a first secondary compartment/first secondary reactor (311) allowing the chemical production of dioxygen, and in that said first compartment/secondary reactor (311) and/or said reactor/compartment main (310) are thermally connected to said cell (1), in that it further comprises means (142) for introducing the diatomic iodine produced in said main compartment/reactor (310) to said second compartment/ secondary reactor (312), means for introducing the sulfuric acid produced in said second compartment/secondary reactor (312) into said first compartment/secondary reactor (311) and means for introduction of the dioxygen produced in said first compartment/secondary reactor (311) to said cell (1) so that the latter serves there as fuel.

16. The system according to claim 15, wherein said chemical reactor/said chemical production unit (3) comprises at least one main compartment/main reactor (310) allowing the chemical production of dihydrogen and di-iodine from iodide of hydrogen, a first secondary compartment/first secondary reactor (311) allowing the chemical production of dioxygen from the reaction between two molecules of sulfuric acid and at least a second secondary compartment/second secondary reactor which allows the reaction between the di-iodine, sulfur oxide and water, which produces hydrogen iodide and sulfuric acid.

17. canceled

18. canceled
